(19) United States
(12) Patent Application Publication
(10) Pub. No.: US 2024/0045999 A1
(43) Pub. Date: Feb. 8, 2024

(54) METHOD AND APPARATUS FOR DETERMINING ANTENNA ARRAY AND ELECTRONIC DEVICE

(71) Applicant: BEIJING JIAOTONG UNIVERSITY, Beijing (CN)

(72) Inventors: Yujian Li, Beijing (CN); Fanqi Sun, Beijing (CN); Junhong Wang, Beijing (CN); Xiaojuan Wang, Beijing (CN)

(21) Appl. No.: 18/337,611

(22) Filed: Jun. 20, 2023

(30) Foreign Application Priority Data
Aug. 8, 2022 (CN) 202210941996.0

(51) Int. Cl. G06F 30/10

(52) U.S. Cl. CPC G06F 30/10

(57) ABSTRACT

The present disclosure provides a method and apparatus for determining an antenna array and an electronic device; the method includes: determining a first target reflection coefficient of each radiation element forming the antenna array based on a pre-acquired antenna array design index; determining a model structure of each radiation element based on the first target reflection coefficient; extracting an amplitude and a phase of a first reflection coefficient from a simulation result of the model structure of a specified radiation element; determining a second target reflection coefficient of each power divider forming the antenna array in a preset calculation mode; determining a model structure of each power divider based on the second target reflection coefficient; and determining the antenna array based on each radiation element with the determined structure and each power divider with the determined structure.

### CROSS-REFERENCE TO RELATED APPLICATION

The present disclosure claims priority of Chinese patent application with the filing number 202210941996.0 filed on Aug. 8, 2022, the contents of which are incorporated herein by reference in their entirety.

### TECHNICAL FIELD

The present disclosure relates to the field of antenna array technologies, and particularly to a method and apparatus for determining an antenna array and an electronic device.

### BACKGROUND ART

A wideband high-gain fixed-beam large-scale antenna array fed by passive feed network is one of important devices for improving a transmission rate of a communication system and reducing a size of the communication system. A design method of the large-scale antenna array usually adopted at present includes: designing and simulating the feed network and the radiating elements forming an array, respectively, then combining the radiating elements and the feed network together, and adjusting parameters of the whole structure to meet design index requirements; however, with an increase of a scale of the array, the design method for integrally adjusting the parameters of the array inevitably increases a demand for computing resources, thereby consuming a large number of computing resources, increasing a computing time cost, and affecting a design efficiency. In implementation of the large-scale wideband high-gain fixed-beam antenna array, since there is no dielectric loss limiting the gain promotion of the array, an air-filled waveguide transmission line is usually configured to form a feed network of the antenna array. A radiating element with wide bandwidth and stable radiation performance and a wideband feed network are key components for a large-scale wideband high-gain fixed-beam array. In order to broaden the impedance matching bandwidth of waveguide-based feed network to improve bandwidth of the antenna array, researchers have conducted various kinds of research work on bandwidth broadening of different types of power divider structures constituting the feed network, and a working bandwidth of a waveguide power divider may be increased to about 60%; however, bandwidth enhancement of the large-scale array is difficult to further improve by improving the impedance bandwidth of the power divider. In summary, in order to further break through a design bottleneck of the high-gain fixed-beam large-scale antenna array, provision of an efficient, convenient and rapid theoretical design method for the large-scale antenna arrays, and design, based on the proposed method, of feed and radiation structures which may be configured to form the antenna array and meet design requirements are necessary for implementation of the high-gain fixed-beam large-scale air-filled waveguide-based antenna array with a wideband, high gain as well as good and stable radiation performance.

### SUMMARY

Various embodiments provide a method and apparatus for determining an antenna array and an electronic device that reduces a design time and improves a design efficiency.

The present disclosure provides a method for determining an antenna array, including steps of: determining a first target reflection coefficient of each radiation element forming the antenna array based on a pre-acquired antenna array design parameters; determining a model structure of each radiation element based on the first target reflection coefficient, wherein the model structures of all the radiation element are the same; extracting an amplitude and a phase of a first reflection coefficient from a simulation result of the model structure of a specified radiation element; determining a second target reflection coefficient of each power divider forming the antenna array in a preset calculation mode based on the amplitude and the phase; determining a model structure of each power divider based on the second target reflection coefficient; and determining the antenna array based on each radiation element with the determined structure and each power divider with the determined structure.

Further, the step of determining a first target reflection coefficient of each radiation element forming the antenna array based on a pre-acquired antenna array design parameters includes: determining an operating frequency band and an array size of the antenna array based on the pre-acquired antenna array design parameters; determining an element spacing between the radiation elements and a waveguide size of each power divider forming the antenna array based on the operating frequency band and the array size; and determining the first target reflection coefficient of each radiation element forming the antenna array according to a preset first calculation equation based on the element spacing, the waveguide size, and a pre-acquired reflection coefficient threshold and resonance depth of each power divider.

Further, the step of extracting an amplitude and a phase of a first reflection coefficient from a simulation result of the model structure of a specified radiation element includes: receiving an instruction of simulating the model structure of a specified radiation element to simulate the model structure of the specified radiation element, so as to obtain the simulation result of the model structure of the specified radiation element, wherein the simulation result includes the first reflection coefficient of the model structure of the specified radiation element; determining whether the first reflection coefficient is matched with the first target reflection coefficient; if no, repeating the step of determining a model structure of each radiation element based on the first target reflection coefficient, so as to obtain the model structure of the specified radiation element corresponding to a first reflection coefficient matched with the first target reflection coefficient; if yes, extracting the amplitude and the phase of the first reflection coefficient from the simulation result of the model structure of the specified radiation element.

Further, after the step of determining a model structure of each power divider based on the second target reflection coefficient, the method includes: receiving an instruction of simulating the model structure of a specified power divider to simulate the model structure of the specified power divider, so as to obtain a simulation result of the model structure of the specified power divider, wherein the simulation result includes a second reflection coefficient of the model structure of the specified power divider; determining whether the second reflection coefficient is matched with the second target reflection coefficient; if no, repeating the step of determining a model structure of each power divider based on the second target reflection coefficient, so as to obtain the model structure of a specified power divider corresponding to a second reflection coefficient matched with the second target reflection coefficient; and determining the model structure of each power divider according to the model structure of the specified power divider.

Further, the second target reflection coefficient includes at least: a resonance number, a resonance frequency point position and a resonance bandwidth; the step of determining whether the second reflection coefficient is matched with the second target reflection coefficient includes: based on the simulation result of the model structure of the specified power divider, determining whether a resonance number, a resonance frequency point position and a resonance bandwidth in the second reflection coefficient are matched with the resonance number, the resonance frequency point position and the resonance bandwidth in the second target reflection coefficient, respectively.

Further, the pre-acquired antenna array design parameters includes a third target reflection coefficient; after the step of determining the antenna array based on each radiation element with the determined structure and each power divider with the determined structure, the method includes: simulating the antenna array to obtain a simulation result of the antenna array, wherein the simulation result includes a third reflection coefficient of the antenna array; determining whether the third reflection coefficient is matched with the third target reflection coefficient; and if no, repeating the step of determining a model structure of each power divider based on the second target reflection coefficient, so as to obtain a specified antenna array corresponding to a third reflection coefficient matched with the third target reflection coefficient.

Further, the model structure of each radiation element includes: a preset number of horn radiation elements, first short straight waveguides with a same number as the horn radiation elements, a common air-filled cavity and a second short straight waveguide, wherein the common air-filled cavity further includes a pair of first triangular irises and a pair of second triangular irises; the common air-filled cavity is provided above the second short straight waveguides, the preset number of first short straight waveguides are arranged above the common air-filled cavity in form of an array, and each horn radiation element is provided above one first short straight waveguide.

Further, the model structure of each power divider includes: a third short straight waveguide and a fourth short straight waveguide, wherein the fourth short straight waveguide is connected to the third short straight waveguide in a T-shaped manner; the fourth short straight waveguide further includes a pair of first irises and a pair of second irises; the third short straight waveguide further includes a matching iris; a symmetrical first capacitive height difference exists between a first output port and a second output port of the third short straight waveguide, and a second capacitive height difference exists at a joint of the third short straight waveguide and the fourth short straight waveguide.

Further, a first output port or a second output port of the model structure of the final stage of power divider is further connected with an adapter structure; the second short straight waveguide is provided above the adapter structure, and the adapter structure is connected with each radiation element by the second short straight waveguide; the adapter structure includes a fifth short straight waveguide, wherein the fifth short straight waveguide further includes a gradual change structure, a third iris and a third triangular iris; and a third capacitive height difference exists between the fifth short straight waveguide and the second short straight waveguide.

The present disclosure provides an apparatus for determining an antenna array, including: a first determining module configured to determine a first target reflection coefficient of each radiation element forming the antenna array based on a pre-acquired antenna array design parameters; a second determining module configured to determine a model structure of each radiation element based on the first target reflection coefficient, wherein the model structures of all the radiation elements are the same; an extracting module configured to extract an amplitude and a phase of a first reflection coefficient from a simulation result of the model structure of a specified radiation element; a third determining module configured to determine a second target reflection coefficient of each power divider forming the antenna array in a preset calculation mode based on the amplitude and the phase; a fourth determining module configured to determine a model structure of each power divider based on the second target reflection coefficient; and a fifth determining module configured to determine the antenna array based on each radiation element with the determined structure and each power divider with the determined structure.

The present disclosure provides an electronic device, including a processor and a memory, wherein the memory stores computer executable instructions executable by the processor, and the processor executes the computer executable instructions to implement any item of the above-mentioned method for determining an antenna array.

The present disclosure provides a computer-readable storage medium, storing computer executable instructions which, when invoked and executed by a processor, cause the processor to implement any item of the above-mentioned method for determining an antenna array.

The present disclosure provides the method and apparatus for determining an antenna array and the electronic device, wherein the method includes: determining the first target reflection coefficient of each radiation element forming the antenna array based on the pre-acquired antenna array design indexes; determining the model structure of each radiation element based on the first target reflection coefficient, wherein the model structures of all the radiation elements are the same; extracting the amplitude and the phase of the first reflection coefficient from the simulation result of the model structure of the specified radiation element; determining the second target reflection coefficient of each power divider forming the antenna array in the preset calculation mode; determining the model structure of each power divider based on the second target reflection coefficient; and determining the antenna array based on each radiation element with the determined structure and each power divider with the determined structure. In the method, complicated design for antenna array is simplified, based on the determined design parameters, into model structure design of the radiation element and model structure design of each power divider forming a parallel feed network, thus reducing the design time and improving the design efficiency.

### BRIEF DESCRIPTION OF DRAWINGS

To describe the technical solutions in the specific embodiments of the present disclosure or the prior art more clearly, the following briefly describes the accompanying drawings required for describing the specific embodiments or the prior art. Apparently, the accompanying drawings in the following description show some embodiments of the present disclosure, and a person of ordinary skill in the art may still derive other drawings from these accompanying drawings without creative efforts.

FIG. 1 is a flow chart of a method for determining an antenna array according to an embodiment of the present disclosure;

FIG. 2 is a schematic topological structural diagram of a large-scale antenna array in an embodiment of the present disclosure;

FIG. 3 is a flow chart of another method for determining an antenna array according to an embodiment of the present disclosure;

FIG. 4 is a design flow chart of another antenna array in an embodiment of the present disclosure;

FIG. 5 is a graph of an S-parameter of a power divider calculated using an optimization algorithm in an embodiment of the present disclosure;

FIG. 6 is a simulation graph of an S-parameter of a model structure of a power divider in an embodiment of the present disclosure;

FIG. 7 is a simulation graph of an S-parameter of an antenna array in an embodiment of the present disclosure;

FIG. 8 is a three-dimensional structural diagram of an antenna array in an embodiment of the present disclosure;

FIG. 9 is a layered structural diagram of an antenna array in an embodiment of the present disclosure;

FIG. 10 is a three-dimensional structural diagram of a model structure of a radiation element in an embodiment of the present disclosure;

FIG. 11 is a side view of a model structure of a radiation element in an embodiment of the present disclosure;

FIG. 12 is a three-dimensional structural diagram of an air-filled waveguide feed network in an embodiment of the present disclosure;

FIG. 13 is a top view of an air-filled waveguide feed network in an embodiment of the present disclosure;

FIG. 14 is a bottom view of an air-filled waveguide feed network in an embodiment of the present disclosure;

FIG. 15 is a right side view of an air-filled waveguide feed network in an embodiment of the present disclosure;

FIG. 16 is a three-dimensional structural diagram of an adapter structure in an embodiment of the present disclosure;

FIG. 17 is a right side view of an adapter structure in an embodiment of the present disclosure;

FIG. 18 is a three-dimensional structural diagram of a waveguide power divider in an embodiment of the present disclosure;

FIG. 19 is a top view of a waveguide power divider in an embodiment of the present disclosure;

FIG. 20 is a three-dimensional structural diagram of another waveguide power divider in an embodiment of the present disclosure;

FIG. 21 is a schematic structural diagram of an apparatus for determining an antenna array according to an embodiment of the present disclosure; and

FIG. 22 is a schematic structural diagram of an electronic device according to an embodiment of the present disclosure.

### DETAILED DESCRIPTION OF EMBODIMENTS

The technical solutions of the present disclosure are described in conjunction with the embodiments, although the described embodiments are not all but a part of the embodiments of the present disclosure. Other embodiments obtained by a person of ordinary skill in the art based on the embodiments of the present disclosure without creative efforts fall within the protection scope of the present disclosure.

A high-gain fixed-beam large-scale antenna array fed by a passive feed network is a core device in a point-to-point wireless communication system, and is widely applied to application scenarios, such as wireless backhaul among remote base stations, indoor wireless access, wireless data transmission of industrial Internet, and in the point-to-point communication system, a method adopted in an existing technical solution is usually coverage of a plurality of operating frequency bands by a plurality of antennas, and a total physical aperture occupied by the plurality of antennas is relatively large.

In order to further increase a transmission rate of the communication system, an antenna having a wideband performance is important to an improvement of a performance of the communication system. On the other hand, a size of the communication system may be remarkably reduced using a wideband antenna array; taking a millimeter-wave point-to-point wireless-communication application frequency band as an example, internationally divided frequency bands include 57-66 GHz, 71-76 GHz, 81-86 GHz, 92-95 GHz, or the like, and in order to simultaneously cover the above communication frequency bands, the total physical aperture of a plurality of antennas which are integrated together may be remarkably reduced using one large-scale antenna array with a relative bandwidth of 50%.

In an aspect of design methods for antenna arrays, current research methods mainly rely on electromagnetic simulation calculation software to perform full-wave simulation calculation, a demand on computing resources is inevitably increased remarkably with an increase of an array size, and realization of the wideband performance of large-scale array using a method of optimizing structural parameters by simulating obviously consumes a large number of computing resources and increases a computing time cost.

Implementation of the wideband high-gain fixed-beam large-scale antenna array usually requires a radiation element structure with wideband and stable radiation characteristics and a wideband passive feed network structure, and although a micro-strip feed network may expand an impedance matching bandwidth of the array, such a micro-strip line structure is mostly implemented on the basis of a dielectric substrate, and dielectric loss in the dielectric substrate may obviously reduce an increase of an array gain; and a wideband feed network with a ridge gap waveguide structure has relatively small power capacity. Rectangular waveguide has higher power capacity. In order to broaden a matching bandwidth of a waveguide-based power divider network to improve the wideband performance of the antenna, researchers have conducted various kinds of research work on bandwidth enhancement of different types of power divider structures constituting the feed network, and a working bandwidth of a waveguide-based power divider may be increased to about 60%; however, bandwidth broadening of the large-scale antenna array is difficult to further improve by improving a performance of the power divider.

In summary, in order to further break through a design bottleneck of the high-gain fixed-beam large-scale antenna array, a method for determining an antenna array is provided to reduce a design time and improve a design efficiency.

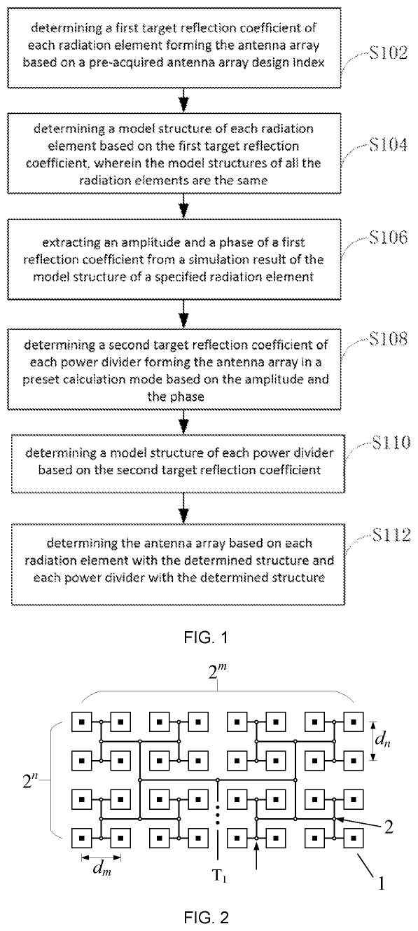

To facilitate understanding of the present embodiment, a method for determining an antenna array according to an embodiment of the present disclosure is first described in detail, and as shown in FIG. 1, the method includes the following steps.

Step S102: determining a first target reflection coefficient of each radiation element forming the antenna array based on a pre-acquired antenna array design index.

In a specific implementation process, the above antenna array is generally a wideband high-gain fixed-beam large-scale antenna array fed by a passive parallel feed network, the above antenna array design index may include a working frequency, an antenna gain, a working bandwidth, or the like, the above radiation elements (terminal loads) are basic components of the antenna, may transmit or receive radio waves, and have various forms, typically such as horns, slots, or the like, and in actual implementation, the antenna array design index may be obtained in advance, and then, the first target reflection coefficient of each radiation element is determined according to the design index, and the antenna array is designed based on the first target reflection coefficient.

Step S104: determining a model structure of each radiation element based on the first target reflection coefficient, wherein the model structures of all the radiation elements are the same.

A planar topology structure of the large-scale antenna array in the present disclosure may be as shown in FIG. 2, and the large-scale antenna array is composed of 2^{m}×2ⁿ radiation elements 1 (terminal loads) and a parallel feed network formed by connecting m+n stages of one-to-two power dividers 2 in parallel (m≥n). The radiation element 1 is generally connected to a tail end of the parallel feed network, the radiation element 1 shown in FIG. 2 is only a schematic diagram, a structural form of the radiation element is not limited to one class of radiation element forms, and specifically, the structural form may be a single radiation structure (such as a horn radiation single element structure), a patch antenna element, a magnetoelectric dipole antenna element, a cavity-backed antenna element, or a radiation structure formed by plural single radiation elements together.

In practical implementation, the model structures of all the radiation elements in the antenna array to be designed are the same, and after the first target reflection coefficient of the radiation element is determined by step S102, the model structure of the radiation element may be determined.

Step S106: extracting an amplitude and a phase of a first reflection coefficient from a simulation result of the model structure of a specified radiation element.

In practical implementation, the above model structure of the specified radiation element may be understood as the model structure of a radiation element satisfying the first target reflection coefficient, and specifically, an electromagnetic full-wave simulation method may be used to verify whether the model structure of the radiation element determined in step S104 satisfies the first target reflection coefficient, and if yes, the amplitude and the phase of the model structure of the radiation element are extracted.

Step S108: determining a second target reflection coefficient of each power divider forming the antenna array in a preset calculation mode based on the amplitude and the phase.

Step S110: determining a model structure of each power divider based on the second target reflection coefficient.

Step S112: determining the antenna array based on each radiation element with the determined structure and each power divider with the determined structure.

In a specific implementation process, after the first target reflection coefficient is determined, the second target reflection coefficient of each power divider may be calculated using an optimization algorithm, and the model structure of each power divider satisfying the second target reflection coefficient is designed. It should be noted that, since waveguide of individual stages of the power dividers has different lengths and individual stages of the power dividers may have different second target reflection coefficients, individual stages of the power dividers have different model structures.

Finally, all the power dividers with the model structures of individual stages of power dividers are cascaded to form a parallel feed network, and the radiation elements with the model structures of the radiation elements are combined with the parallel feed network to complete final antenna array design.

The above method for determining an antenna array includes: determining the first target reflection coefficient of each radiation element forming the antenna array based on the pre-acquired antenna array design parameters; determining the model structure of each radiation element based on the first target reflection coefficient, wherein the model structures of all the radiation elements are the same; extracting the amplitude and the phase of the first reflection coefficient from the simulation result of the model structure of the specified radiation element; determining the second target reflection coefficient of each power divider forming the antenna array in the preset calculation mode; determining the model structure of each power divider based on the second target reflection coefficient; and determining the antenna array based on each radiation element with the determined structure and each power divider with the determined structure. In the method, complicated antenna array design is simplified, based on the determined design parameters, into model structure design for the radiation element and model structure design for each power divider forming a parallel feed network, thus reducing the design time and improving the design efficiency.

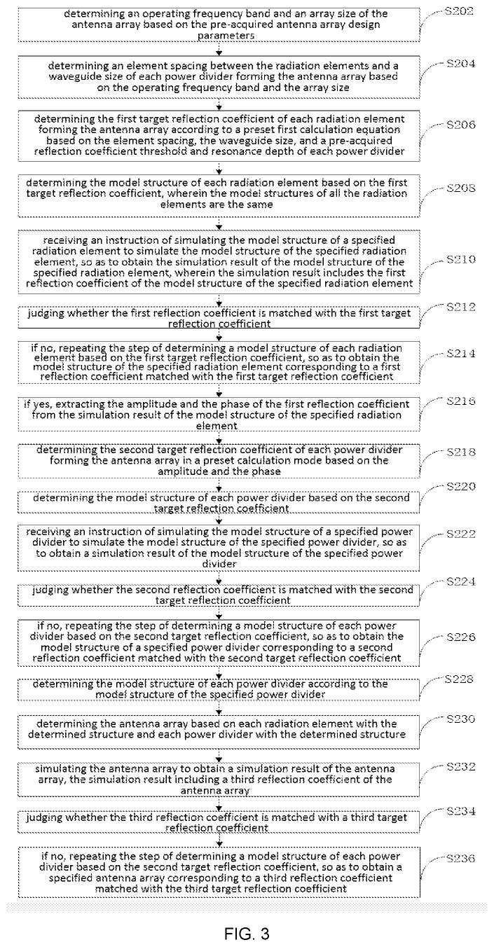

An embodiment of the present disclosure further provides another method for determining an antenna array, the method is implemented on the basis of the method according to the above-mentioned embodiment, and as shown in FIG. 3, the method includes the following steps.

Step S202: determining an operating frequency band and an array size of the antenna array based on the pre-acquired antenna array design parameters.

In a specific implementation process, referring to a schematic topological structural diagram of a large-scale antenna array shown in FIG. 2, the radiation element 1 in FIG. 2 refers to one class of structures formed by combining one or more structures and connected to the tail end of the feed network, which is not limited to a single radiation element or a combination of plural single radiation elements, and may also include a corresponding coupling feed or direct feed structure, and as a terminal load, a reflection coefficient of the radiation element corresponds to Γ_{L} in the reflection coefficient calculation equation (1) of primary reflection model.

For convenience of description of a formation form of the large-scale antenna array, it is specified that element spacing in dimension directions of 2m radiation elements 1 and 2n radiation elements 1 are dₘ and dₙ, respectively, the whole feed network has m+n one-to-two power dividers, the power divider directly connected with the radiation elements 1 is an (m+n)th one-to-two power divider, a corresponding node is named Tₘ₊ₙ, a reflection coefficient at this node is Γₘ₊ₙ, a transmission coefficient at this node is Tᵣ_{ₘ₊ₙ}, and other reflection nodes are done in a same manner until a first reflection node T₁. The individual stages of power dividers are connected in sequence to form a parallel feed network model which may be connected with the 2m×2n radiation elements 1. A path length between adjacent nodes is named Iᵢ, a corresponding calculation equation is shown in (3), a total path length from the first reflection node T1 to the ith reflection node Tᵢ is Lᵢ, and a corresponding calculation equation is shown in (5).

$${Γ}_{in} = {Γ}_{1} + {\sum }_{i = 2}^{m + n} ( {Γ}_{i} \cdot {e}^{- 2 j {θ}_{i - 1}} \cdot {{\prod }_{2}}^{i} {Tr}_{i - 1} ) + {Γ}_{L} \cdot {e}^{- 2 j {θ}_{m + n}} \cdot {{\prod }_{1}}^{m + n} {Tr}_{i} \qquad Equation ( 1 )$$

The above equation (1) is the reflection coefficient calculation equation of primary reflection model, and specifically, the equation (1) may be obtained according to equations (2) to (5) below, wherein Γᵢₙ is a reflection coefficient of the antenna array, Γ₁ is the reflection coefficient of the first stage of power divider at the first node, Γᵢ is the reflection coefficient of the ith stage of power divider at the ith node, Tᵣ_{_{i−1}} is the transmission coefficient of the (i−1)th stage of power divider at the (i−1)th node, Tᵣ_{ᵢ} is the transmission coefficient of the ith stage of power divider at the ith node, and Γ_{L} is a reflection coefficient of each radiation element 1.

θᵢ=βLᵢ Equation (2)

wherein θ is the phase, β is a phase constant, and L is the length of a total path to the ith reflection node Tᵢ.

$${l}_{i} = \{ \begin{matrix}{d}_{m} \cdot {2}^{m - \frac{i + 1}{2} - 1} , & i is an odd number \\ & ( m \geq n , 1 \leq i \leq m + n , i is an integer ) \\ {d}_{n} \cdot {2}^{n - \frac{i}{2} - 1} , & i is an even number\end{matrix} \qquad Equation ( 3 )$$

$${Tr}_{i} = 1 + {Γ}_{i} \qquad Equation ( 4 )$$

$${L}_{i} = {l}_{i} + {l}_{i - 1} , {L}_{0} = 0 \qquad Equation ( 5 )$$

Step S204: determining an element spacing between the radiation elements and a waveguide size of each power divider forming the antenna array based on the operating frequency band and the array size.

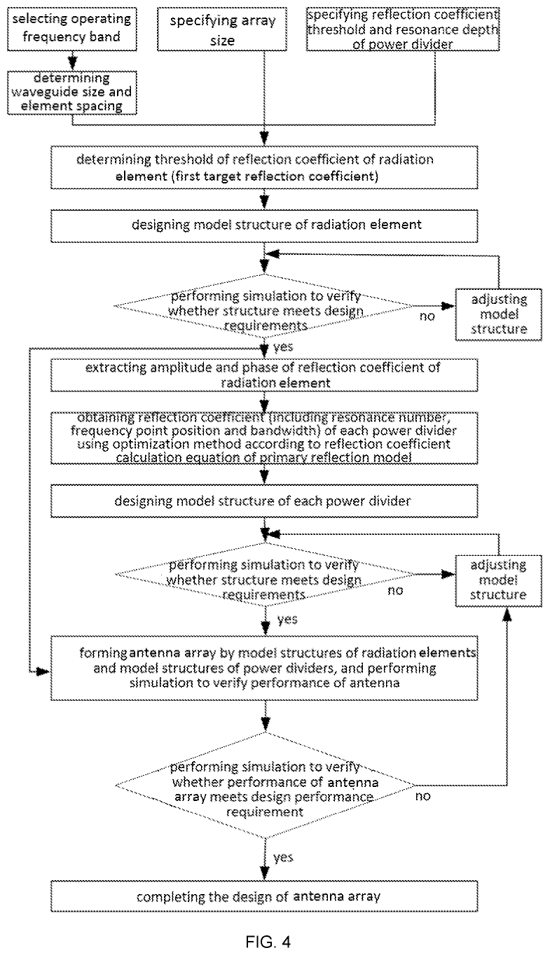

To further understand the present embodiment, the present disclosure is described in conjunction with a design flow chart of an antenna array shown in FIG. 4. Firstly, according to design index requirements, the operating frequency band of the designed large-scale antenna array is selected, the array size thereof is specified, and the element spacing dₘ and dₙ between the radiation elements 1 and the size of a waveguide structure of waveguide type transmission line (which is equivalent to the waveguide size of each power divider forming the antenna array mentioned above) are further calculated.

Step S206: determining the first target reflection coefficient of each radiation element forming the antenna array according to a preset first calculation equation based on the element spacing, the waveguide size, and a pre-acquired reflection coefficient threshold and resonance depth of each power divider.

The above-mentioned reflection coefficient threshold and resonance depth of each power divider may be obtained in advance according to limited experiments, and in practical implementation, the waveguide size, the element spacing (dₘ and dₙ), the array size (2^{m}×2ⁿ), and the reflection coefficient threshold 31 (maximum reflection coefficient) and resonance depth 32 of each power divider may be used as an initial condition, and then, frequency points at which the reflection coefficient of the large-scale antenna array is large are estimated according to the reflection coefficient calculation equation (1) of primary reflection model; if the reflection coefficient of the power divider is in a small state at the frequency points generating these high reflection coefficients (corresponding to the given resonance depth 32 in the initial condition, i.e., the lowest reflection coefficient), in order to make the reflection coefficients of these frequency points generating the high reflection coefficients and limiting bandwidth broadening of the large-scale antenna array still meet the design requirements, such as |S₁₁| less than −10 dB, a voltage standing wave ratio (VSWR) less than 2, or the like, the reflection coefficient Γ_{L} (first target reflection coefficient) of each radiation element 1 may be calculated according to the given initial condition in conjunction with the reflection coefficient calculation equation (1) of primary reflection model.

Step S208: determining the model structure of each radiation element based on the first target reflection coefficient, wherein the model structures of all the radiation elements are the same.

The reflection coefficient Γ_{L} of the above radiation element 1 is used as the reflection coefficient threshold 31 (maximum reflection coefficient) of the model structure of a radiation element to be designed, and then, the model structure (terminal load structure) of the radiation element is designed.

Step S210: receiving an instruction of simulating the model structure of a specified radiation element to simulate the model structure of the specified radiation element, so as to obtain the simulation result of the model structure of the specified radiation element, wherein the simulation result includes the first reflection coefficient of the model structure of the specified radiation element.

Step S212: determining (or judging) whether the first reflection coefficient is matched with the first target reflection coefficient.

Step S214: if no, repeating the step of determining a model structure of each radiation element based on the first target reflection coefficient, so as to obtain the model structure of the specified radiation element corresponding to a first reflection coefficient matched with the first target reflection coefficient.

Step S216: if yes, extracting the amplitude and the phase of the first reflection coefficient from the simulation result of the model structure of the specified radiation element.

In a specific implementation process, the electromagnetic full-wave simulation method may be adopted to verify whether a performance (first reflection coefficient) of the model structure of the designed radiation element meets the design requirement (whether the first reflection coefficient is matched with the first target reflection coefficient), if no, the model structure of the radiation element is required to be readjusted until the performance meets the design requirement (the first reflection coefficient is matched with the first target reflection coefficient), and if the performance meets the design requirement, amplitude and phase information of the reflection coefficient Γ_{L} (first reflection coefficient) of the model structure of the designed radiation element is directly extracted.

Step S218: determining the second target reflection coefficient of each power divider forming the antenna array in a preset calculation mode based on the amplitude and the phase.

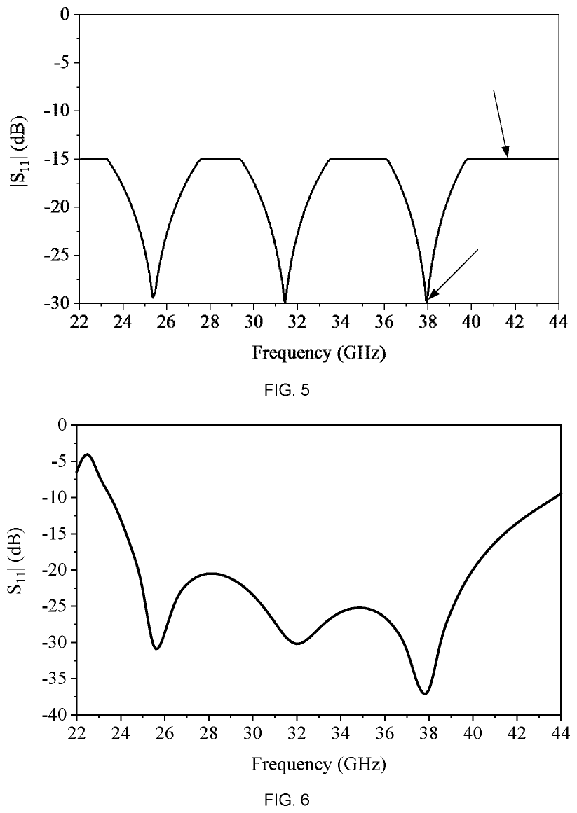

During specific implementation, the extracted amplitude and phase information of the reflection coefficient Γ_{L} (first reflection coefficient) of the model structure of the designed radiation element 1 may be substituted into the reflection coefficient calculation equation (1) of primary reflection model, the working bandwidth of the array is set as an optimization target (for example, the reflection coefficient |Γᵢₙ| of an input port of the large-scale antenna array within the operating frequency band range of 26-40 GHz<−10 dB) according to the design index requirement, the reflection coefficient (equivalent to the second target reflection coefficient) of each power divider forming the feed network is calculated using an optimization method, and specifically, the reflection coefficient Γᵢ (S parameter curve in FIG. 5) of the power divider may be obtained using the optimization algorithm (including, but not limited to, a genetic algorithm, a differential evolution algorithm, a co-evolution algorithm, a distribution estimation algorithm, or the like).

Step S220: determining the model structure of each power divider based on the second target reflection coefficient.

For the above reflection coefficient (second target reflection coefficient) of each power divider, reference may be made to the graph of an S-parameter of the power divider calculated using the optimization algorithm shown in FIG. 5. According to FIG. 5, key design indexes (including a resonance number, a resonance frequency position, a bandwidth at a resonance frequency point, or the like) of each power divider to be designed may be obtained, and then, according to the resonance number, the resonance frequency position, and the bandwidth at the resonance frequency point included in the reflection coefficient Γᵢ of the power divider, the model structure of each power divider meeting requirements may be designed.

The design method of the wideband high-gain fixed-beam large-scale antenna array involved in FIG. 4 has clear design steps, complicated large-scale antenna array design is simplified, based on the determined design indexes, into radiation element (terminal load) structural design and design of the power divider forming the parallel feed network according to the reflection coefficient calculation equation of primary reflection model constructed by the small reflection theory in conjunction with the optimization method, which greatly reduces a computing time and computing resources occupied by the electromagnetic full-wave simulation for the large-scale antenna array, and the provided design method is simple and may improve the design efficiency of the large-scale antenna array.

Step S222: receiving an instruction of simulating the model structure of a specified power divider to simulate the model structure of the specified power divider, so as to obtain a simulation result of the model structure of the specified power divider, wherein the simulation result includes a second reflection coefficient of the model structure of the specified power divider.

Step S224: determining (or judging) whether the second reflection coefficient is matched with the second target reflection coefficient.

Step S226: if no, repeating the step of determining a model structure of each power divider based on the second target reflection coefficient, so as to obtain the model structure of a specified power divider corresponding to a second reflection coefficient matched with the second target reflection coefficient.

Step S228: determining the model structure of each power divider according to the model structure of the specified power divider.

In a specific implementation process, the electromagnetic full-wave simulation method may be used to verify whether a performance (second reflection coefficient) of the model structure of the designed power divider meets the design requirement (whether the second reflection coefficient is matched with the second target reflection coefficient). Specifically, since the second target reflection coefficient at least includes: a resonance number, a resonance frequency point position and a resonance bandwidth, whether the resonance number, the resonance frequency point position and the resonance bandwidth in the second reflection coefficient (see the simulation graph of an S-parameter of a model structure of a power divider shown in FIG. 6) are matched with the resonance number, the resonance frequency point position and the resonance bandwidth in the second target reflection coefficient can be determined respectively based on the simulation result of the model structure of the specified power divider, and if no, the model structure of the power divider is readjusted until the resonance number, the resonance frequency point position and the resonance bandwidth in the second reflection coefficient are matched with the resonance number, the resonance frequency point position and the resonance bandwidth in the second target reflection coefficient.

During actual implementation, the instruction of simulating the model structure of the specified power divider (currently designed power divider) may be received, full-wave simulation verification may be performed using simulation software, and the second reflection coefficient (including the resonance number, the resonance frequency point position and the resonance bandwidth) of the model structure of the power divider is changed by adjusting the model structure of the power divider until each designed power divider meets the design indexes.

Step S230: determining the antenna array based on each radiation element with the determined structure and each power divider with the determined structure.

Step S232: simulating the antenna array to obtain a simulation result of the antenna array, the simulation result including a third reflection coefficient of the antenna array.

Step S234: determining (or judging) whether the third reflection coefficient is matched with a third target reflection coefficient.

Step S236: if no, repeating the step of determining a model structure of each power divider based on the second target reflection coefficient, so as to obtain a specified antenna array corresponding to a third reflection coefficient matched with the third target reflection coefficient.

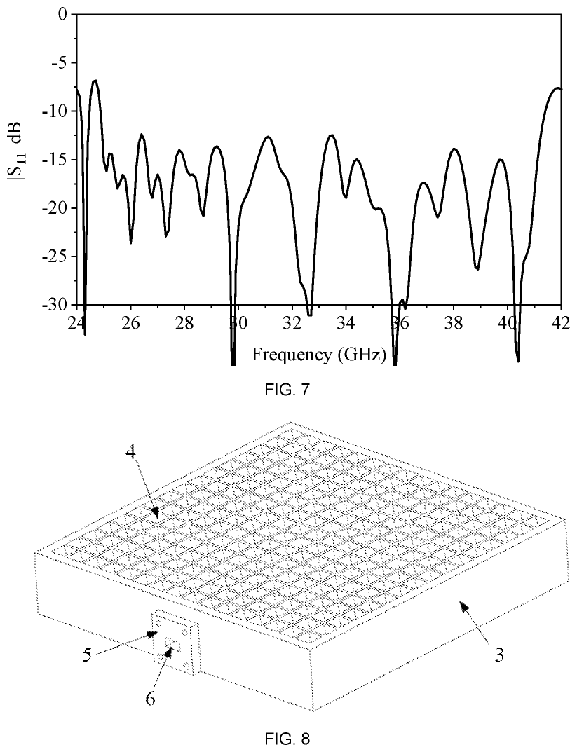

In a specific implementation process, the third target reflection coefficient may be determined according to the pre-acquired antenna array design index; the radiation elements 1 with the model structures of the designed radiation elements and the parallel feed network obtained by cascading the power dividers with the model structure of each designed power divider are combined into an array, the array is verified in electromagnetic full-wave simulation software, the model structure of each power divider is required to be readjusted if the third reflection coefficient obtained by simulation (see the simulation graph of an S-parameter of an antenna array shown in FIG. 7) is not matched with the third target reflection coefficient, the design steps are repeated until the large-scale antenna array obtained by simulation completely meets the design index requirements, and finally, antenna design is completed through processing, testing and verifying.

The present disclosure provides a design flow method for bandwidth enhancement of large-scale antenna array based on a multi-resonance point tuning technology of power divider for the large-scale antenna array with a topological structure shown in FIG. 1, and the provided design method may obviously reduce a calculation cost and shorten a design cycle of the large-scale antenna array. In the above method for determining an antenna array, the reflection coefficient Γ_{L} of the designed radiation element structure 1 (terminal load) is substituted into the reflection coefficient calculation equation (1) of primary reflection model provided based on a topological structure of large-scale antenna array, the reflection coefficient Γᵢ of each power divider is calculated using the optimization algorithm, and multi-resonance point tunability is realized through corresponding structural design, such that the resonance frequency point and the resonance depth are consistent with an inversion calculation result Γᵢ; finally, the designed element structure 1 (terminal load) is combined with the parallel feed network formed by cascading the plural power dividers to finish the final design, thus efficiently realizing the design of the wideband large-scale antenna array.

In order to better understand the above embodiments, in the present application, according to the design flow method of an antenna array shown in FIG. 4, a large-scale wideband fixed-beam high-gain antenna array is designed, and has a radiation element structure with wide bandwidth and stable radiation characteristics, a wideband adapter interconnection structure, and a wideband impedance-matching power divider structure facilitating regulation and control of resonance frequency points. The antenna array has a simple and compact structure, is easy to implement, has a better operating frequency band and a more stable gain characteristic, and may realize effective distribution and efficient transmission of electromagnetic energy.

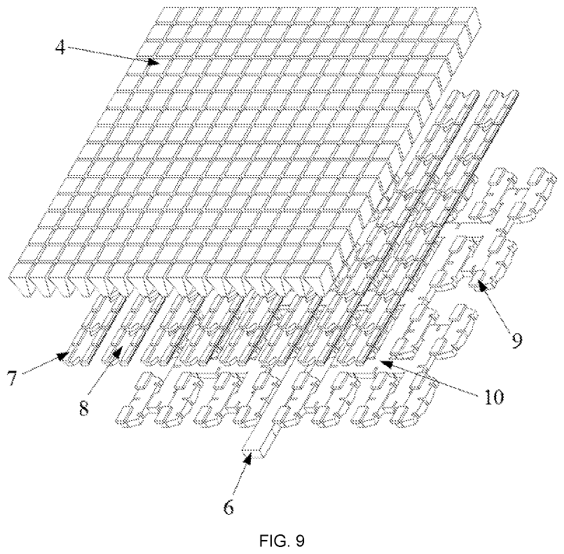

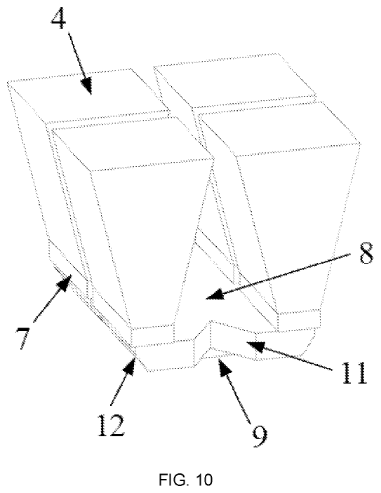

FIG. 8 shows a three-dimensional structural diagram of an antenna array; FIG. 9 is a layered structural diagram of an antenna array; specifically, in the present embodiment, the antenna array may be in an air-filled waveguide antenna array structure with 16×16 horn radiation elements, and in practical implementation, the antenna array structure may be embedded in a metal matrix 3, and connected with a radio frequency link by a left flange 5, electromagnetic energy is fed from a left input port 6 to an air-filled waveguide feed network 10 of the air-filled waveguide-based antenna array, the electromagnetic energy is evenly distributed to tail ends 13 of the feed network 10 by individual stages of power divider structures 14, the electromagnetic energy is coupled into an air-filled feed cavity 8 by short straight air-filled waveguide 9 and is distributed therein, and the electromagnetic energy is coupled into the horn radiation elements 4 by short straight air-filled waveguide 7 with equal amplitude and in phase, and is radiated to a free space.

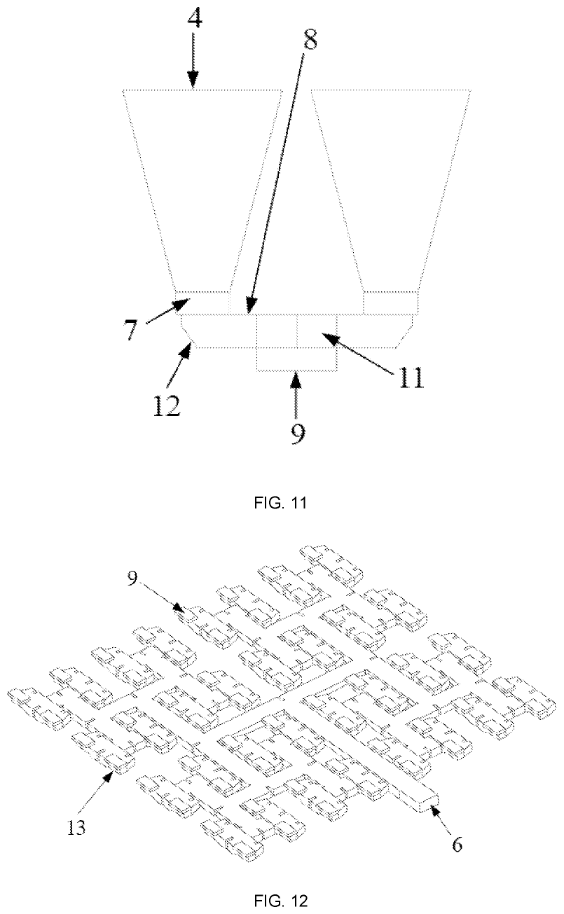

From a three-dimensional structural diagram of a model structure of a radiation element shown in FIG. 10 and a side view of a model structure of a radiation element shown in FIG. 11, it can be seen that the model structure adopted by the radiation element 1 forming the above antenna array structure may include: a preset number of horn radiation elements 4, first short straight waveguide 7 with a same number as the horn radiation elements, a common air-filled feed cavity 8 and a second short straight waveguide 9; the common air-filled feed cavity 8 further includes a pair of first triangular irises 11 and a pair of second triangular irises 12; the common air-filled feed cavity 8 is provided above the second short straight waveguide 9, the preset number of first short straight waveguides 7 are arranged above the common air-filled feed cavity 8 in form of an array, and each horn radiation element 4 is provided above one first short straight waveguide 7.

In the present embodiment, the model structure adopted by the radiation element 1 is composed of 2×2 horn radiation element structures 4, 4 short straight waveguide structures (the first short straight waveguide units) 7, 1 common air-filled feed cavity (the common air-filled feed cavity) 8, and a short straight air-filled waveguide (the second short straight waveguide) 9 jointly. In order to realize wideband impedance matching between the air-filled feed cavity 8 and the horn radiation element structures 4, a pair of inward triangular irises (the first triangular iris) 11 and a pair of triangular irises (the second triangular irises) 12 are further provided into the air-filled feed cavity 8.

It should be noted that, in the present embodiment, only one configuration form of the radiation element 1 is given, and in addition, any one of radiation element structure forms of a single radiation element, a patch radiation element, a magneto-electric dipole, a helical antenna radiation element, a back cavity antenna radiation element, a slot radiation element, or the like, may be adopted, and meanwhile, the irises 11 and 12 introduced into the air-filled feed cavity 8 may be implemented in a form including, but not limited to, a triangle, a rectangle, a trapezoid, a multi-order rectangle, or other continuously gradual change matching structure design.

By the topological structure of large-scale antenna array shown in FIG. 2 in the present embodiment, it may be determined that the array size calculated using the optimization algorithm is 2³×2³, and the parallel feed network is formed by sequentially arranging and cascading 6 stages of different one-to-two power divider structures 14. In a specific implementation process, the reflection coefficient Γ_{L} obtained by simulating the radiation element 1 may be substituted into the reflection coefficient calculation equation (1) of primary reflection model for calculation, and correspondingly, a feed network scale and the element spacing (dₘ and dₙ) are modified to guarantee accuracy and reliability of the calculation result.

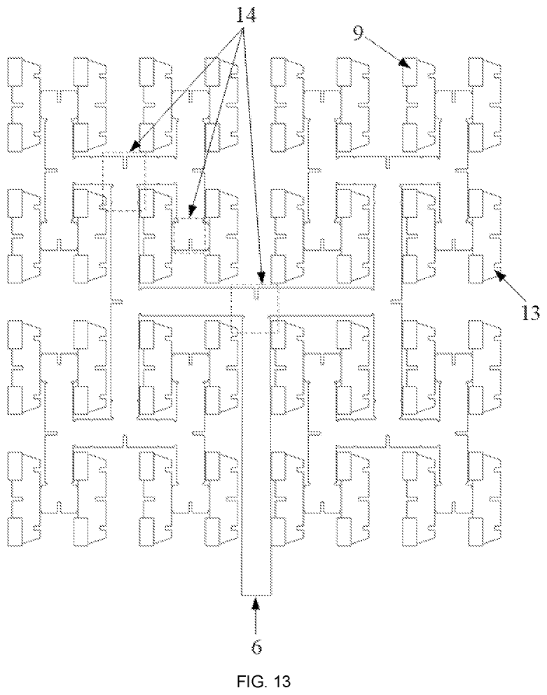

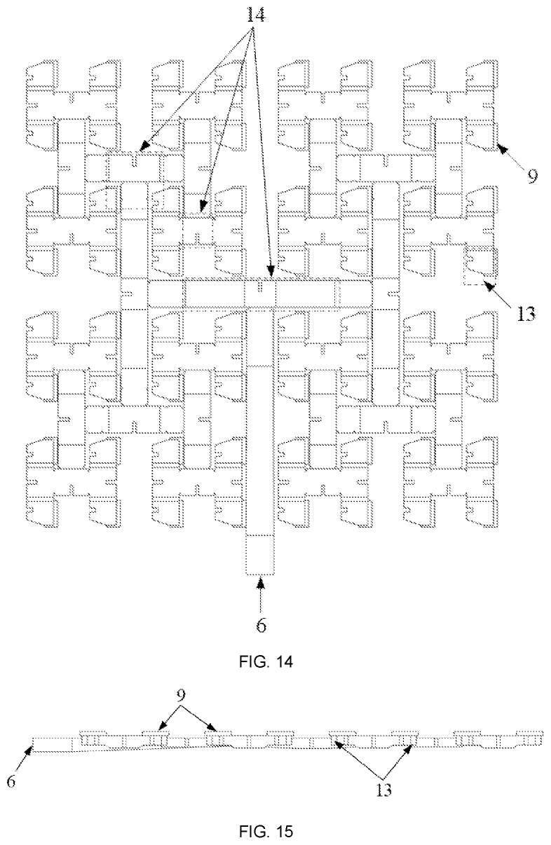

During practical implementation, the parallel feed network forming the above antenna array structure is generally an air-filled waveguide feed network 10. Specifically, from a three-dimensional structural diagram of an air-filled waveguide feed network shown in FIG. 12, a top view of an air-filled waveguide feed network shown in FIG. 13, a bottom view of an air-filled waveguide feed network shown in FIG. 14, and a right side view of an air-filled waveguide feed network shown in FIG. 15, it can be seen that the air-filled waveguide feed network is formed by cascading 6 stages of air-filled waveguide power dividers 14.

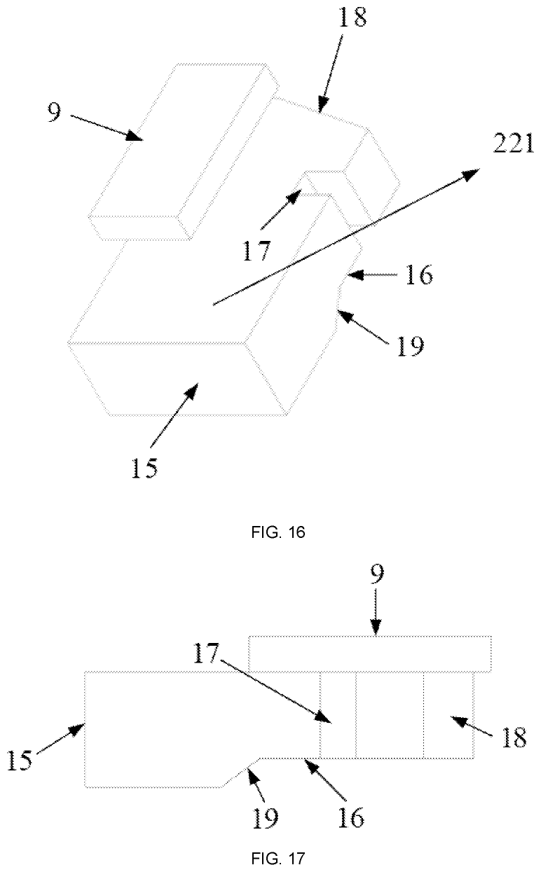

In order to realize good transmission of the electromagnetic energy between the air-filled waveguide feed network 10 and the radiation element 1, an adapter structure 13 is connected to a first output port or a second output port of the model structure 14 of each of all the final stage of air-filled waveguide power dividers; referring to a three-dimensional structural diagram of an adapter structure shown in FIG. 16 and a right side view of an adapter structure shown in FIG. 17, it may be learnt that the second short straight waveguide 9 is provided above the adapter structure 13, and the adapter structure may be connected with each radiation element 1 by the second short straight waveguide 9.

Herein, the broadband adapter structure 13 for connecting the final stage of air waveguide power divider 14 in the air-filled waveguide feed network 10 and the radiation element 1 includes: a fifth short straight waveguide 221, and the fifth short straight waveguide 221 further includes a gradual change structure 19, a third iris 17, and a third triangular iris 18; and a third capacitive height difference 16 exists between the fifth short straight waveguide 221 and the second short straight waveguide 9.

A port 15 at one end of the above fifth short straight waveguide 221 may be used as an input port of the adapter structure 13, and is connected with one output port of the final stage of waveguide power divider. In order to realize good transmission of the electromagnetic energy, a height difference (the third capacitive height difference) 16, the gradual change structure 19, the triangular iris structure (the third triangular iris) 18, a iris (the third iris) 17 extending to the side of short straight air-filled waveguide, or the like, exist between a narrow side of the port 15 and a waveguide narrow side of a connecting part of the second short straight waveguide 9. It should be noted that, in the present embodiment, the designed height difference 16 and gradual change structure 19 of the adapter structure are in a mutually dependent relationship, and matching may also be realized without using the height difference 16. In addition, the gradual change structure 19 is similar to the triangular iris structure 18, and may be a shown corner cut structure, or is a matching structure having a specific mathematical expression form, such as a multi-order rectangle, sine, cosine, parabola, or the like, and the iris 17 may be a shown rectangular iris, a triangular iris, a trapezoidal iris, a multi-order rectangle iris, or the like.

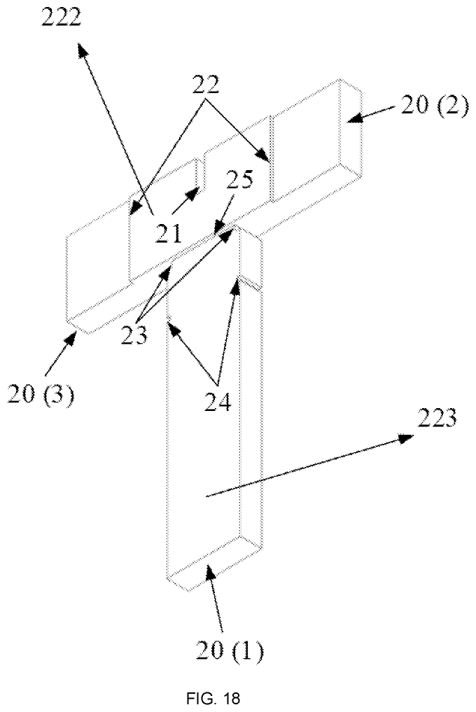

By adopting the designed wideband radiation element 1 with the good and stable radiation characteristics and the wideband adapter structure 13, in conjunction with the design method for wideband large-scale antenna array (the method for determining an antenna array) according to the present disclosure, the reflection coefficients of the individual stages of power dividers 14 are determined using the optimization method, and design requirements may be meet by the designed multi-resonance-point tunable wideband power divider structure 14 shown in FIGS. 18 to 20, thereby realizing the wideband design of the large-scale antenna array.

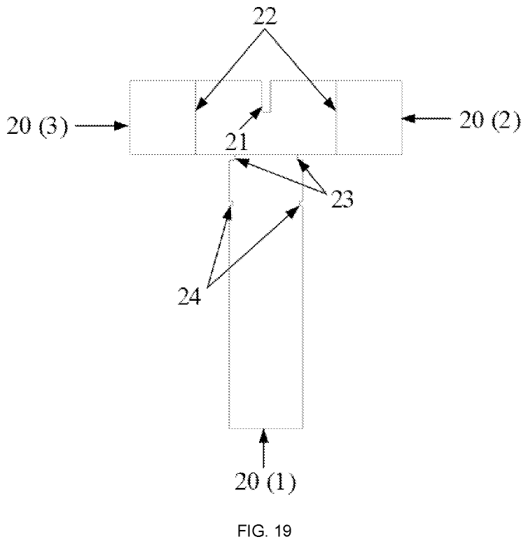

FIGS. 18 to 20 show two wideband power divider structures 14 which may realize multi-resonance point tunability. From a three-dimensional structural diagram of a waveguide power divider shown in FIG. 18 and a top view of a waveguide power divider shown in FIG. 19, it can be seen that such waveguide power divider structure (the model structure of the power divider) includes: a third short straight waveguide 222 and a fourth short straight waveguide 223; the fourth short straight waveguide 223 is connected to the third short straight waveguide 222 in a T-shaped manner; the fourth short straight waveguide 223 further includes a pair of first irises 23 and a pair of second irises 24; the third short straight waveguide 222 further includes a matching iris 21; and a symmetrical first capacitive height difference 22 exists between a first output port 20(3) and a second output port 20(2) of the third short straight waveguide 222, and a second capacitive height difference 25 exists at a joint of the third short straight waveguide 222 and the fourth short straight waveguide 223.

Specifically, the electromagnetic energy is input from an input branch (third output port) 20(1) of the fourth short straight waveguide 223 of each waveguide power divider 14, and evenly distributed to 2 output branches (the second output port 20(2) and the first output port 20(3)), and one of the 2 output branches may be connected with the input branch 20(1) of the next power divider, such that the individual stages of power dividers 14 are structurally interconnected to finally realize the parallel air-filled waveguide feed network 10.

In order to realize the design of the wideband power divider and the multi-resonance-frequency-point tunable function, the matching iris 21 is introduced between two output branches 20(2) and 20(3) of the power divider towards the side of input branch 20(1), two arms of the two output branches have same capacitive height difference structures (the first capacitive height difference) 22, a capacitive height difference (the second capacitive height difference) 25 exists at a joint of the third short straight waveguide 222 and the fourth short straight waveguide 223, a pair of iris structures (the first irises) 23 extending towards an inner side of waveguide (the fourth short straight waveguide) 223 are arranged adjacent to the joint, and a pair of iris structures (the second irises) 24 extending towards an interior of the waveguide are arranged on the fourth short straight waveguide 223 at a distance from the joint.

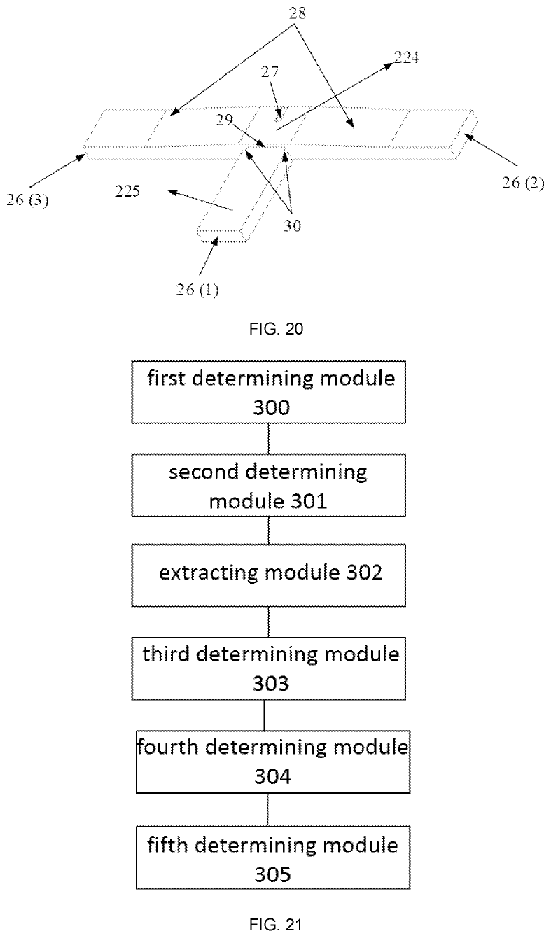

Another kind of design of a multi-resonance-point tunable wideband power divider is shown in FIG. 20, and from a three-dimensional structural iris of another waveguide power divider shown in FIG. 20, it can be seen that such a waveguide power divider structure (the model structure of the power divider) includes: a seventh short straight waveguide 224 and a sixth short straight waveguide 225. The seventh short straight waveguide 224 is connected to the sixth short straight waveguide 225 in a T-shaped manner. The sixth short straight waveguide 225 further includes a pair of fourth irises 30, and the seventh short straight waveguide 224 further includes a matching iris 27 and a pair of capacitive gradual change structures 28. A fourth capacitive height difference 29 exists at a joint of the seventh short straight waveguide 224 and the sixth short straight waveguide unit 225.

In order to realize wideband impedance matching and multi-resonance-frequency-point tunability, the matching iris 27 is introduced between two output branches (output ports) 26(2) and 26(3) of the power divider towards the side of input branch (input port) 26(1), the capacitive gradual change structures 28 are arranged on the two output branches, a capacitive height difference (the fourth capacitive height difference) 29 exists at the joint of the seventh short straight waveguide 224 and the sixth short straight waveguide 225, and a pair of iris structures (the fourth irises) 30 extending towards an inner side of waveguide (the sixth short straight waveguide) 225 are arranged close to the joint.

By adjusting structural parameters of the wideband power divider 14 shown in the above embodiment, 1 to 4 resonance frequency points may be implemented. The structural parameters may be understood as physical sizes, such as length, width, height, or the like, of the model structure forming the above air waveguide-based power divider, and adjustment of the structural parameters means change of these sizes. Taking 3 resonance frequency points as an example, in order to achieve the optimized reflection coefficient (the second target reflection coefficient) of the power divider shown in FIG. 5, the power divider structure 14 in the embodiment may be adjusted to obtain the graph of the S-parameter (the second reflection coefficient of the power divider) shown in FIG. 6. Obviously, the resonance number, the resonance frequency point position, and the resonance bandwidth in FIGS. 5 and 6 are kept consistent, such that the multi-resonance-point tunable wideband power divider designed in the above embodiment has a multi-resonance-frequency-point tunable function, and thus tuning of plural resonance frequency points is realized.

It should be noted that, in the embodiment, only one expression form of the power divider structure 14 is given, and the present disclosure includes, but is not limited to, characteristic forms improved based on this structure, which may be specifically as follows: the capacitive height difference at the joint of the input branch and the output branch may be located on either upper or lower side of the short side of the waveguide, or both sides of the short side of the waveguide; the iris structures 23, 24 and 30 extending inwards on the input branch may be rectangular, triangular, arc-shaped and hemispherical, a number of the iris structures 24 on the input branch is not limited, and distances from the iris structures to the joint are not fixed; structural shapes of the matching irises 21 and 27 may be rectangles, triangles, multi-order rectangles, trapezoids, shapes formed by gradual change curves with specific mathematical expression forms, or the like; and the capacitive gradual change structure 28 may also be in a multi-step gradual change form, or the like, and the capacitive height difference structure 22 has an unfixed distance from a center line of the two arms of the output branches, has an unfixed length, and may be located on either upper or lower side of the long side of the rectangular waveguide, or both sides thereof at the same time.

An embodiment of the present disclosure further provides an apparatus for determining an antenna array, as shown in FIG. 21, including: a first determining module 300 configured to determine a first target reflection coefficient of each radiation element forming the antenna array based on a pre-acquired antenna array design index; a second determining module 301 configured to determine a model structure of each radiation element based on the first target reflection coefficient, wherein the model structures of all the radiation elements are the same; an extracting module 302 configured to extract an amplitude and a phase of a first reflection coefficient from a simulation result of the model structure of a specified radiation element; a third determining module 303 configured to determine a second target reflection coefficient of each power divider forming the antenna array in a preset calculation mode based on the amplitude and the phase; a fourth determining module 304 configured to determine a model structure of each power divider based on the second target reflection coefficient; and a fifth determining module 305 configured to determine the antenna array based on each radiation element with the determined structure and each power divider with the determined structure.

The above apparatus for determining an antenna array determines the first target reflection coefficient of each radiation element forming the antenna array based on the pre-acquired antenna array design index; determines the model structure of each radiation element based on the first target reflection coefficient, wherein the model structures of all the radiation elements are the same; extracts the amplitude and the phase of the first reflection coefficient from the simulation result of the model structure of the specified radiation element; determines the second target reflection coefficient of each power divider forming the antenna array in the preset calculation mode; determines the model structure of each power divider based on the second target reflection coefficient; and determines the antenna array based on each radiation element with the determined structure and each power divider with the determined structure. In the apparatus, complicated antenna array design is simplified, based on the determined design index, into model structure design of the radiation element and model structure design of each power divider forming a parallel feed network, thus reducing a design time and improving a design efficiency.

Further, the first determining module is further configured to determine a operating frequency band and an array size of the antenna array based on the pre-acquired antenna array design index; determine an element spacing between the radiation elements and a waveguide size of each power divider forming the antenna array based on the operating frequency band and the array size; and determine the first target reflection coefficient of each radiation element forming the antenna array according to a preset first calculation equation based on the element spacing, the waveguide size, and a pre-acquired reflection coefficient threshold and resonance depth of each power divider.

Further, the extracting module is further configured to receive an instruction of simulating the model structure of a specified radiation element to simulate the model structure of the specified radiation element, so as to obtain the simulation result of the model structure of the specified radiation element, the simulation result including the first reflection coefficient of the model structure of the specified radiation element; determine whether the first reflection coefficient is matched with the first target reflection coefficient; if no, repeat the step of determining a model structure of each radiation element based on the first target reflection coefficient, so as to obtain the model structure of the specified radiation element corresponding to a first reflection coefficient matched with the first target reflection coefficient; if yes, extract the amplitude and the phase of the first reflection coefficient from the simulation result of the model structure of the specified radiation element.

Further, the apparatus further receives an instruction of simulating the model structure of a specified power divider to simulate the model structure of the specified power divider, so as to obtain a simulation result of the model structure of the specified power divider, the simulation result including a second reflection coefficient of the model structure of the specified power divider; determines whether the second reflection coefficient is matched with the second target reflection coefficient; if no, repeats the step of determining a model structure of each power divider based on the second target reflection coefficient, so as to obtain the model structure of a specified power divider corresponding to a second reflection coefficient matched with the second target reflection coefficient; and determines the model structure of each power divider according to the model structure of the specified power divider.

Further, the second target reflection coefficient includes at least: a resonance number, a resonance frequency point position and a resonance bandwidth; and the apparatus further, based on the simulation result of the model structure of the specified power divider, determines whether a resonance number, a resonance frequency point position and a resonance bandwidth in the second reflection coefficient are matched with the resonance number, the resonance frequency point position and the resonance bandwidth in the second target reflection coefficient, respectively.

Further, the apparatus further simulates the antenna array to obtain a simulation result of the antenna array, the simulation result including a third reflection coefficient of the antenna array; determines whether the third reflection coefficient is matched with the third target reflection coefficient; and if no, repeats the step of determining a model structure of each power divider based on the second target reflection coefficient, so as to obtain a specified antenna array corresponding to a third reflection coefficient matched with the third target reflection coefficient.

Further, the model structure of each radiation element includes: a preset number of horn radiation elements, first short straight waveguides with a same number as the horn radiation elements, a common air-filled feed cavity and a second short straight waveguide; the common air-filled feed cavity further includes a pair of first triangular irises and a pair of second triangular irises; the common air-filled feed cavity is provided above the second short straight waveguide, the preset number of first short straight waveguides are arranged above the common air-filled feed cavity unit in form of an array, and each horn radiation element is provided above one first short straight waveguide.

Further, the model structure of each power divider includes: a third short straight waveguide and a fourth short straight waveguide; the fourth short straight waveguide is connected to the third short straight waveguide in a T-shaped manner; the fourth short straight waveguide further includes a pair of first irises and a pair of second irises; the third short straight waveguide further includes a matching iris; a symmetrical first capacitive height difference exists between a first output port and a second output port of the third short straight waveguide, and a second capacitive height difference exists at a joint of the third short straight waveguide and the fourth short straight waveguide.

Further, a first output port or a second output port of the model structure of the final stage of power divider is further connected with an adapter structure; the second short straight waveguide is provided above the adapter structure, and the adapter structure is connected with each radiation element by the second short straight waveguide; the adapter structure includes a fifth short straight waveguide, and the fifth short straight waveguide further includes a gradual change structure, a third iris and a third triangular iris; and a third capacitive height difference exists between the fifth short straight waveguide and the second short straight waveguide.

The apparatus for determining an antenna array according to the embodiment of the present disclosure has the same implementation principle and technical effects as the method for determining an antenna array according to the embodiment, and for details of the embodiment of the apparatus for determining an antenna array, reference may be made to the corresponding content in the embodiment of the method for determining an antenna array.

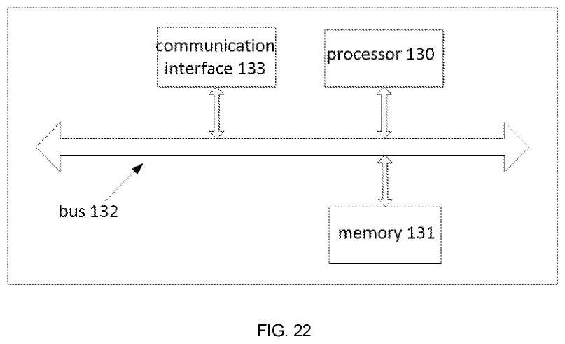

An embodiment of the present disclosure further provides an electronic device, as shown in FIG. 22, including a processor 130 and a memory 131, wherein the memory 131 stores machine executable instructions executable by the processor 130, and the processor 130 executes the machine executable instructions to implement the above-mentioned method for determining an antenna array.

Further, the electronic device shown in FIG. 22 further includes a bus 132 and a communication interface 133, and the processor 130, the communication interface 133, and the memory 131 are connected by the bus 132.

Herein, the memory 131 may include a high-speed random access memory (RAM) or a non-volatile memory, such as at least one disk memory. Communication connection between a system network element and at least one other network element is implemented through the at least one communication interface 133 (which may be wired or wireless), and the Internet, a wide area network, a local area network, a metropolitan area network, or the like, may be used. The bus 132 may be an ISA bus, PCI bus, EISA bus, or the like. The bus may be divided into an address bus, a data bus, a control bus, or the like. For ease of representation, the bus is represented by only one double-headed arrow in FIG. 22, but this does not mean that only one bus or one type of buses exists.

The processor 130 may be an integrated circuit chip having a signal processing capability. In an implementation process, the steps of the above method may be completed by integrated logic circuits of hardware or instructions in the form of software in the processor 130. The processor 130 may be a general-purpose processor, including a central processing unit (CPU), a network processor (NP), or the like; or a digital signal processor (DSP), an application specific integrated circuit (ASIC), a field-programmable gate array (FPGA) or other programmable logic devices, discrete gate or transistor logic devices, or discrete hardware components. Various methods, steps, and logic blocks in the embodiments of the present disclosure may be implemented or executed. The general-purpose processor may be a microprocessor, any conventional processor, or the like. The steps of the method according to the embodiments of the present disclosure may be directly implemented by a hardware decoding processor, or implemented by a combination of hardware and software modules in a decoding processor. The software module may be located in a storage medium well known in the art, such as a random access memory, a flash memory, a read-only memory, a programmable read-only memory, an electrically erasable programmable memory, a register, or the like. The storage medium is located in the memory 131, and the processor 130 reads information in the memory 131, and completes the steps of the method according to the foregoing embodiment in combination with hardware thereof.

An embodiment of the present disclosure further provides a computer-readable storage medium storing computer executable instructions which, when invoked and executed by a processor, cause the processor to implement the above-mentioned method for determining an antenna array. For specific implementation, reference may be made to the method embodiment, and details are not repeated herein.

The method and apparatus for determining an antenna array and the electronic device according to the embodiments of the present disclosure include a computer-readable storage medium storing a program code, wherein instructions included in the program code may be used to execute the method according to the foregoing method embodiment, and for specific implementation, reference may be made to the method embodiment, and details are not repeated herein.

When implemented in the form of software functional units and sold or used as independent products, the functions can be stored in a computer-readable storage medium. Based on such an understanding, the technical solutions of the present disclosure essentially, or the part contributing to the prior art, or a part of the technical solutions may be implemented in the form of a software product. The computer software product is stored in a storage medium and includes several instructions for instructing a computer device (which may be a personal computer, a server, or a network device) to perform all or a part of steps of the method described in the embodiment of the present disclosure. Moreover, the above-mentioned storage medium includes various media capable of storing program codes, such as a USB flash disk, a mobile hard disk, a read-only memory (ROM), a random access memory (RAM), a magnetic disk, or an optical disk.

Finally, it should be noted that the above embodiments are only used to illustrate the technical solutions of the present disclosure, not to limit the present disclosure; although the present disclosure is described in detail with reference to the above embodiments, those having ordinary skill in the art should understand that they still can modify technical solutions recited in the aforesaid embodiments or equivalently replace partial or all technical features therein; these modifications or substitutions do not make essence of corresponding technical solutions depart from the scope of technical solutions of embodiments of the present disclosure.

What is claimed is:

1. A method for determining an antenna array comprising:
determining a first target reflection coefficient of each radiation element forming the antenna array based on a pre-acquired antenna array design index;
determining a model structure of each radiation element based on the first target reflection coefficient, wherein model structures of all radiation elements are the same;
extracting an amplitude and a phase of a first reflection coefficient from a simulation result of a model structure of a specified radiation element;
determining a second target reflection coefficient of each power divider forming the antenna array in a preset calculation mode based on the amplitude and the phase;
determining a model structure of each power divider based on the second target reflection coefficient; and
determining the antenna array based on each radiation element with a determined structure and each power divider with a determined structure.

2. The method of claim 1, wherein determining the first target reflection coefficient comprises:
determining a operating frequency band and an array size of the antenna array based on the pre-acquired antenna array design index;
determining an element spacing between the radiation elements and a waveguide size of each power divider forming the antenna array based on the operating frequency band and the array size; and
determining the first target reflection coefficient of each radiation element forming the antenna array according to a preset first calculation equation based on the element spacing, the waveguide size, and a pre-acquired reflection coefficient threshold and resonance depth of each power divider.

3. The method of claim 1, wherein the extracting comprises:
receiving an instruction of simulating the model structure of the specified radiation element to simulate the model structure of the specified radiation element, so as to obtain the simulation result of the model structure of the specified radiation element, wherein the simulation result comprises the first reflection coefficient of the model structure of the specified radiation element;
determining whether the first reflection coefficient is matched with the first target reflection coefficient; and
repeating, if the first reflection is not matched with the first target reflection coefficient, the determining a model structure of each radiation element based on the first target reflection coefficient, so as to obtain the model structure of the specified radiation element corresponding to a first reflection coefficient matched with the first target reflection coefficient; or
extracting, if the first reflection is matched with the first target reflection coefficient, the amplitude and the phase of the first reflection coefficient from the simulation result of the model structure of the specified radiation element.

4. The method of claim 1, after determining the model structure, the method further comprises:
receiving an instruction of simulating a model structure of a specified power divider to simulate the model structure of the specified power divider, so as to obtain a simulation result of the model structure of the specified power divider, wherein the simulation result comprises a second reflection coefficient of the model structure of the specified power divider;
determining whether the second reflection coefficient is matched with the second target reflection coefficient;
repeating, if the second reflection is not matched with the second target reflection coefficient, the determining a model structure of each power divider based on the second target reflection coefficient, so as to obtain the model structure of the specified power divider corresponding to a second reflection coefficient matched with the second target reflection coefficient; and
determining the model structure of each power divider according to the model structure of the specified power divider.

5. The method of claim 4, wherein the second target reflection coefficient comprises at least one of a resonance number, a resonance frequency point position or a resonance bandwidth; and the determining whether the second reflection coefficient is matched with the second target reflection coefficient comprises:
determining, based on the simulation result of the model structure of the specified power divider, whether a resonance number, a resonance frequency point position and a resonance bandwidth in the second reflection coefficient are matched with the resonance number, the resonance frequency point position and the resonance bandwidth in the second target reflection coefficient, respectively.

6. The method of claim 1, wherein the pre-acquired antenna array design index comprises a third target reflection coefficient, and wherein the method further comprises, after determining the antenna array:
simulating the antenna array to obtain a simulation result of the antenna array, wherein the simulation result comprises a third reflection coefficient of the antenna array;
determining whether the third reflection coefficient is matched with a third target reflection coefficient; and
repeating, if the third reflection is not matched with the third target reflection coefficient, the determining a model structure of each power divider based on the second target reflection coefficient, so as to obtain a specified antenna array corresponding to a third reflection coefficient matched with the third target reflection coefficient.

7. The method of claim 1, wherein the model structure of each radiation element comprises a preset number of horn radiation elements, first short straight waveguides with a same number as the horn radiation elements, a common air-filled feed cavity and a second short straight waveguide unit, wherein the common air-filled feed cavity further comprises a pair of first triangular irises and a pair of second triangular irises, and wherein the common air-filled feed cavity is provided above the second short straight waveguide, the preset number of first short straight waveguides are arranged above the common air-filled feed cavity in form of an array, and each horn radiation element is provided above one first short straight waveguide.

8. The method of claim 1, wherein the model structure of each power divider comprises a third short straight waveguide and a fourth short straight waveguide, wherein the fourth short straight waveguide is connected to the third short straight waveguide in a T-shaped manner, wherein the fourth short straight waveguide further comprises a pair of first irises and a pair of second irises, wherein the third short straight waveguide further comprises a matching iris, and wherein a symmetrical first capacitive height difference exists between a first output port and a second output port of the third short straight waveguide, and a second capacitive height difference exists at a joint of the third short straight waveguide and the fourth short straight waveguide.

9. The method of claim 8, wherein a first output port or a second output port of a model structure of a final stage of power divider is further connected with an adapter structure, wherein a second short straight waveguide is provided above the adapter structure, wherein the adapter structure is connected with each radiation element by the second short straight waveguide, wherein the adapter structure comprises a fifth short straight waveguide, and the fifth short straight waveguide further comprises a gradual change structure, a third iris and a third triangular iris, and wherein a third capacitive height difference exists between the fifth short straight waveguide and the second short straight waveguide.

10. An apparatus for determining an antenna array, comprising:
a first determining module configured to determine a first target reflection coefficient of each radiation element forming the antenna array based on a pre-acquired antenna array design index;
a second determining module configured to determine a model structure of each radiation element based on the first target reflection coefficient, wherein model structures of all radiation elements are the same;
an extracting module configured to extract an amplitude and a phase of a first reflection coefficient from a simulation result of a model structure of a specified radiation element;
a third determining module configured to determine a second target reflection coefficient of each power divider forming the antenna array in a preset calculation mode based on the amplitude and the phase;
a fourth determining module configured to determine a model structure of each power divider based on the second target reflection coefficient; and
a fifth determining module configured to determine the antenna array based on each radiation element with a determined structure and each power divider with a determined structure.

11. An electronic device comprising a memory and a processor, wherein the memory stores a computer program operable on the processor, and the processor executes the computer program to implement the method of claim 1.
